(19) United States
(12) Patent Application Publication
(10) Pub. No.: US 2002/0139958 A1
(43) Pub. Date: Oct. 3, 2002

(54) WETTING AGENT COMPRISTING SULFONATED DICARBOXYLIC ESTERS

(76) Inventors: GERHARD AUCHTER, DURKHEIM (DE); ANDREE DRAGON, SPEYER (DE); ORAL AYDIN, MANNHEIM (DE); FRIEDRICH WIRSING, SPEYER (DE)

Correspondence Address: OBLON SPIVAK MCCLELLAND MAIER & NEUSTADT, 1755 JEFFERSON DAVIS HIGHWAY, FOURTH FLOOR, ARLINGTON, VA, 22202

(21) Appl. No.: 09/450,951

(22) Filed: Nov. 29, 1999

(30) Foreign Application Priority Data
Dec. 1, 1998 (DE) 19855353.6

(51) Int. Cl. C08F 2/16

(52) U.S. Cl. 252/364

(57) ABSTRACT

A solution comprises a salt of a monoalkyl or dialkyl ester of a sulfonated dicarboxylic acid a) and an organic solvent b) having a boiling point of more than 250° C. at 1 bar.

The invention relates to a solution comprising a salt of a monoalkyl or dialkyl ester of a sulfonated dicarboxylic acid a) and an organic solvent b) having a boiling point of more than 250° C. at 1 bar.

The invention also relates to the use of the solution as a wetting agent, especially in aqueous polymer dispersions.

Aqueous polymer dispersions are applied to a wide variety of substrates as coatings or adhesives, for example. To achieve good substrate wetting and a largely smooth and flawless surface the polymer dispersions generally comprise wetting agents.

Dialkyl esters of sulfonated succinic acids are known as wetting agents from, for example, D. J. Calvert et al., EUROPEAN ADHESIVES & SEALANTS; June 1966, pages 2 to 5.

A disadvantage when using wetting agents, including the derivatives of sulfonated succinic acid in particular, is the severe foaming. This foaming reaches a critical extent especially in the high-speed coating units which are customary nowadays, and prevents the development of flawless surfaces.

It is an object of the present invention to provide wetting agents having an extremely low foaming tendency.

We have found that this object is achieved by the solution defined above, by its use as a wetting agent and by aqueous polymer dispersions comprising said wetting agent.

The solution of the invention comprises a salt of a monoalkyl or dialkyl ester of a sulfonated dicarboxylic acid, referred to below for short as a).

The dicarboxylic acid preferably has 4 to 8 carbon atoms and in particular is succinic acid (HOOC—CH₂—CH₂—COOH). The dicarboxylic acid is sulfonated, i.e., substituted by at least and preferably one sulfonate group.

One or both carboxyl groups are esterified with alkanols, so that the compound is present as a monoalkyl or dialkyl ester. The number of carbon atoms in the alkyl groups is preferably from 2 to 20, with particular preference from 4 to 16 and, with very particular preference, from 4 to 12. Dialkyl esters are preferred, with particular preference being given to di-C₄-C₁₂-alkyl esters, e.g., dioctyl or di-2-ethylhexyl esters.

Preferred cations of the salt a) are the alkali metal cations or the ammonium cation. In particular, therefore, a) is the alkali metal salt or ammonium salt of a dialkyl ester of sulfonated succinic acid.

A particularly preferred compound is sodium di(2-ethylhexyl)sulfosuccinate or the corresponding potassium or ammonium compound.

The organic solvent b) is liquid at 21° C. and 1 bar and has a boiling point of more than 250° C. at 1 bar. The solvent b) is therefore a non-volatile compound in accordance with EU Directive 96/13/EC (Official Journal of the European Communities No. L4 of Jan. 6, 1996, pages 8 to 13).

The solvent b) is preferably a surfactant, i.e., a compound which reduces the surface tension of water. The reduction in surface tension can be determined using the known techniques such as by measuring the contact angle, for example. b) is preferably aliphatic.

In particular, b) is a polyhydric or, preferably, monohydric alcohol whose hydroxyl group(s) is (are) alkoxylated.

Preference is given to alcohols having 10-20, especially 12-15, carbon atoms. The hydroxyl groups are on average alkoxylated with from 3 to 10 mol of alkoxy groups per mole of hydroxyl groups. Propoxy or ethoxy groups are particularly suitable, particular preference being given to ethoxy groups.

In addition to a) and b), the solution may have further constituents. A particularly suitable further constituent is water as diluent or cosolvent.

Preferably, a) is soluble in b) under standard conditions (21° C., 1 bar), the solubility being in particular at least 20 parts by weight of a) in 100 parts by weight of b).

Preferred solutions contain from 50 to 500, more preferably from 100 to 400 and, with particular preference, from 200 to 350 parts by weight of a) per 100 parts by weight of b).

Water is used if at all preferably in amounts from 1 to 300, more preferably from 100 to 200 parts by weight per 100 parts by weight of b).

The solution can be simply prepared by mixing the constituents. Preferably, first a) is dissolved in b) and then water, if desired, is added for dilution.

The solution is suitable as a wetting agent. In particular, the solution is suitable as a wetting agent for polymers, preferably those obtainable by free-radical addition polymerization.

At least 60% by weight of the polymers consist preferably of C₁-C₁₈ alkyl acrylates or methacrylates, vinylaromatics with up to 20 carbon atoms, vinyl esters of C₁-C₂₀ carboxylic acids, ethylenically unsaturated nitrites, vinyl halides, vinyl ethers of C₁-C₁₀ alcohols, and aliphatic hydrocarbons with 2 to 8 carbon atoms and 1 or 2 double bonds, or mixtures of these monomers.

At least 60% by weight of preferred polymers consist of C₁-C₁₈ alkyl acrylates or methacrylates, vinylaromatics with up to 20 carbon atoms, or aliphatic, conjugated dienes with 4 to 8 carbon atoms, or mixtures of these monomers.

The polymers are preferably in the form of an aqueous dispersion as obtained, for example, by emulsion polymerization of the monomers.

The solution is used as a wetting agent preferably in amounts from 0.1 to 10, with particular preference from 0.2 to 5 and, with very particular preference, from 0.2 to 3 parts by weight of solution per 100 parts by weight of polymer.

In the case of aqueous polymer dispersions the solution of the invention is simply added to the dispersion and the system is stirred.

The solution of the invention can also be used as an emulsifier in the case, for example, of emulsion polymerization.

For that purpose the monomers are dispersed in water using the solution of the invention and then the emulsion polymerization is conducted in a conventional manner. When used as an emulsifier, the proportion by weight of the solution of the invention corresponds to that indicated above.

When the polymers or polymer dispersions are applied to a wide variety of substrates comprising, for example, plastic, metal, wood and paper, the solution acts as a wetting agent and leads to the development of a smooth and flawless polymer surface. Very good surfaces can also be obtained, in particular, with flexible substrates, such as polymer films or siliconized paper.

The solution contains no volatile organic solvents having a boiling point below 250° C. (1 bar).

When used in aqueous polymer dispersions, prior art wetting agents often cause foaming on application to surfaces. Especially when using aqueous polymer dispersions as adhesives, as, for example, in the coating of labels, it has been impossible to obtain uniform surfaces in this way.

With the solution of the invention little or no foaming is observed even on high-speed coating units (as used, for example, to coat labels).

### EXAMPLES

### I. Wetting agents (B)

B1 (in accordance with the invention)

Solution of

71% by weight of sodium di(2-ethylhexyl)sulfosuccinate (DOSS)

29% by weight of a C₁₃ alcohol (EO alcohol) ethoxylated with on average 5 mol of ethylene oxide (EO)

(B1 was diluted further with 45 parts by weight of water which, however, are not counted when calculating the amount by weight of wetting agent).

B2 (for comparison)

100% by weight of DOSS

(B2 was dissolved in a water/propylene glycol mixture which, however, is not counted when calculating the amount by weight of wetting agent).

B3 (for comparison)

100% by weight of EO alcohol

### II. Test methods and results

The wetting agents were added to a pressure-sensitive adhesive (PSA) mixture comprising 75 parts (based on solids) of a commercial acrylate PSA dipersion (Acronal® V210, manufacturer: BASF AG, Ludwigshafen, Germany) and 25 parts (based on solids) of an aqueous rosin dispersion (Tacolyn (®3179, manufacturer: Hercules BV, Middelburg, Netherlands). (Amount in table)

The adhesives were subsequently adjusted with water to an efflux time of 19 seconds, measured in the DIN 4 flowcup in accordance with DIN 53211.

Testing the wetting behavior

The adhesive mixtures are applied to siliconized paper using a box-type coating bar with a gap height of 50 μm. After waiting for 10 seconds the wetted area is determined by estimation as a percentage of the area originally coated with dispersion. The wetting behavior is better the greater the area still wetted after this time. The figure reported in the table is the wetted area in % as an average of a 5-fold determination.

Testing the foaming behavior

Test device: 1000 ml glass beaker (height 14.5 cm, diameter 10.5 cm) Basket stirrer (height 5.5 cm, diameter 4.1 cm) with 15 rows each of 20 offset holes (hole diameter 3 mm, hole spacing 3 mm) Teflon-clad metal scraper

Initial volume: 500 ml

Procedure:

500 ml of dispersion are placed in the glass beaker. The basket stirrer is immersed in the dispersion so that the upper three rows of holes of the stirrer are outside the dispersion. A Teflon-clad metal scraper is placed at an angle of about 45 degrees to the stirrer, and the stirrer is rotated at 500 revolutions per minute. At fixed intervals of time, the rise of the foam volume in the glass beaker is measured. The table indicates the foam height after 120 minutes.

TABLE

| Experi- | Wetting | Amount* | Wetted | Foam |
|---|---|---|---|---|
| ment No. | agent | % by wt. | area % | height |
| 1 | B1 | 0.8 | 60 | 750 ml |
| 2 | B2 | 0.57** | 45 | 750 ml |
| 3 | B2 | 0.8 | 65 | >1000 ml*** |
| 4 | B3 | 0.8 | 25 | — |

*based on adhesive solids
**corresponds to same amount of DOSS as in Experiment No. 1
***after only 82 minutes

Comparison of Experiment 1 with Experiment 3 in particular shows clearly that foaming can be reduced in accordance with the invention and the wetting effect remains the same with the same amount of wetting agent (despite the markedly smaller amount of DOSS).

We claim:

1. A solution comprising a salt of a monoalkyl or dialkyl ester of a sulfonated dicarboxylic acid a) and an organic solvent b) having a boiling point of more than 250° C. at 1 bar.

2. A solution as claimed in claim 1, wherein a) is a dialkyl ester.

3. A solution as claimed in claim 1, wherein a) is a dialkyl ester of sulfonated succinic acid.

4. A solution as claimed in claim 1, wherein a) is an alkali metal salt or an ammonium salt of the dialkyl ester of sulfonated succinic acid.

5. A solution as claimed in claim 1, wherein the solvent b) is a surfactant.

6. A solution as claimed in claim 1, wherein the solvent b) is an alkoxylated alcohol.

7. A solution as claimed in claim 1, containing from 50 to 500 parts by weight of compound a) per 100 parts by weight of solvent b).

8. The use of a solution as claimed in claim 1 as a wetting agent in an aqueous polymer dispersion.

9. The use of a solution as claimed in claim 1 as an emulsifier in emulsion polymerization.

10. An aqueous polymer dispersion comprising a solution as claimed in claim 1.

11. The use of an aqueous polymer dispersion as claimed in claim 10 to coat polymer films or siliconized paper.
